(19) United States
(12) Patent Application Publication
(10) Pub. No.: US 2026/0299380 A1
(43) Pub. Date: Oct. 1, 2026

(54) TEMPERATURE CONTROL SYSTEM AND CAMERA DEVICE USING THE SAME

(71) Applicant: ABILITY ENTERPRISE CO., LTD., New Taipei City (TW)

(72) Inventors: Chia-Hung HSU, New Taipei City (TW); Yu-Ting Shih, New Taipei City (TW); Jhe-Ming Lin, New Taipei City (TW)

(21) Appl. No.: 19/554,713

(22) Filed: Mar. 3, 2026

(30) Foreign Application Priority Data
Mar. 31, 2025 (TW) 114203250

(51) Int. Cl. G03B 17/55; G02B 27/00

(52) U.S. Cl. CPC G03B 17/55; G02B 27/0006

(57) ABSTRACT

The proposed temperature control system can apply to camera devices. The system includes a first heater, a second heater, a first temperature control module, a second temperature control module, and a processing module. The first temperature control module electrically connects to the first heater. The second temperature control module electrically connects to the second heater. The processing module electrically connects to both the first and second temperature control modules. Thus, the temperature control system can automatically determine the temperature and adjust it accordingly, eliminating the need for manual adjustment.

This application claims the benefit of Taiwan application Serial No. 114203250, filed Mar. 31, 2025, the subject matter of which is incorporated herein by reference.

### BACKGROUND OF THE INVENTION

### Field of the Invention

The invention relates in general to a temperature control system and a camera device using the same, and more particularly to a temperature control system with a heating function and a camera device using the same.

### Description of the Related Art

When an outdoor temperature drops to a dew point, a window of a device may fog up, and accordingly it affects the device's functionality. Especially for the outdoor device in extreme weather condition, the window is more prone to fogging. Therefore, how to improve the fogging problem of the window of the device is one of the goals of companies in this technical field.

### SUMMARY OF THE INVENTION

The present invention provides a temperature control system and a camera device using the same, which can improve the aforementioned known problems.

According to an embodiment of the present invention, a temperature control system is provided. The temperature control system includes a first heater, a second heater, a first temperature control module, a second temperature control module and a processing module. The first temperature control module electrically connects to the first heater. The second temperature control module electrically connects to the second heater. The processing module electrically connects to the first temperature control module and the second temperature control module.

According to another embodiment of the present invention, a camera device is provided. The camera device includes a temperature control system and a window. The temperature control system includes a first heater, a second heater, a first temperature control module, a second temperature control module and a processing module. The first temperature control module electrically connects to the first heater. The second temperature control module electrically connects to the second heater. The processing module electrically connects to the first temperature control module and the second temperature control module. The window connects to the second heater.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a functional block diagram of a temperature control system according to an embodiment of the present invention;

FIG. 2 shows a schematic diagram of a temperature control system disposed on a camera device according to another embodiment of the present invention;

FIG. 3A shows a schematic diagram of the camera device in FIG. 1 in Mode 1;

FIG. 3B shows a schematic diagram of the camera device in FIG. 1 in Mode 2;

FIG. 3C shows a schematic diagram of the camera device in FIG. 1 in Mode 3; and

FIG. 3D shows a schematic diagram of the camera device in FIG. 1 in Mode 3.

### DETAILED DESCRIPTION OF THE INVENTION

Variations of the present invention will be described in detail below, with illustrations provided. In addition to these detailed descriptions, the present invention may be widely implemented in other embodiments. Any simple substitution, modification or equivalent change to the described embodiments are included within the scope of the present invention. In the description of the specification, many specific details and implementation examples are provided to provide the reader a more complete understanding of the present invention; however, these specific details and implementation examples should not be considered as limitations of the present invention. Furthermore, well-known steps or elements are not described in the details to avoid unnecessary limitations on the present invention.

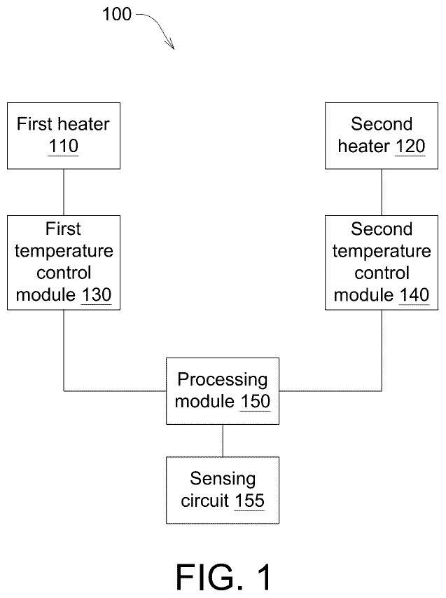

Referring to FIG. 1, FIG. 1 shows a functional block diagram of a temperature control system 100 according to an embodiment of the present invention. The temperature control system 100 can be applied to a device with a window or a light-transmitting baffle, or a device prone to fogging, wherein the device includes but not limited to a mirror, the window, a camera device and a vehicle windshield. This embodiment takes the temperature control system 100 applied to the window of a lens module of a camera device for illustration, but it is not intended to limit the invention.

As shown in FIG. 1, the temperature control system 100 includes a first heater 110, a second heater 120, a first temperature control module 130, a second temperature control module 140, a processing module 150, and a sensing circuit (or temperature sensing circuit) 155. The first temperature control module 130 electrically connects to the first heater 110. The second temperature control module 140 electrically connects to the second heater 120. The processing module 150 electrically connects to the first temperature control module 130 and the second temperature control module 140. In an embodiment, the first temperature control module 130, the second temperature control module 140 and the processing module 150 can automatically control at least one of the first heater 110 and the second heater 120 to operate according to different scenarios.

Table 1 shows how the first heater 110, the second heater 120, and the processing module 150 are set to be activated (or turned on), deactivated (or turned off) or intermittently activated in different modes for managing a power usage efficiency and an achieve energy saving.

TABLE 1

| | Mode 1 | Mode 2 | Mode 3 | Mode 4 |
|---|---|---|---|---|
| the first heater 110 | ON | OFF | OFF | OFF |
| the second heater 120 | ON | ON | intermittently | OFF |
| | | | activates | |
| processing module 150 | OFF | ON | ON | ON |

In Mode 1, both of the first heater 110 and the second heater 120 are activated, and the processing module 150 is deactivated; in Mode 2, the first heater 110 is deactivated, and both of the processing module 150 and the second heater 120 are activated; in mode 3, the first heater 110 is deactivated, the second heater 120 is intermittently activated, and the processing module 150 is activated; and in Mode 4, both of the first heater 110 and the second heater 120 are deactivated, and the processing module 150 is activated. By using these four modes, at least one of the first heater 110, the second heater 120 and the processing module 150 can be deactivated respectively, and accordingly it saves overall operating power consumption.

In an embodiment, mode 1 can be a scenario where the sensed temperature is lower than a first predetermined temperature value Tem1; mode 2 can be a scenario where the sensed temperature ranges between the first predetermined temperature value Tem1 and a second predetermined temperature value Tem2; mode 3 can be a scenario where the sensed temperature ranges between the second predetermined temperature value Tem2 and a third predetermined temperature value Tem3; and mode 4 can be a scenario where the sensed temperature is higher than the third predetermined temperature value Tem3. Wherein, the first predetermined temperature value Tem1 is less than the second predetermined temperature value Tem2 (Tem1<Tem2), and the second preset temperature Tem2 is less than the third predetermined temperature value Tem3 (Tem2<Tem3).

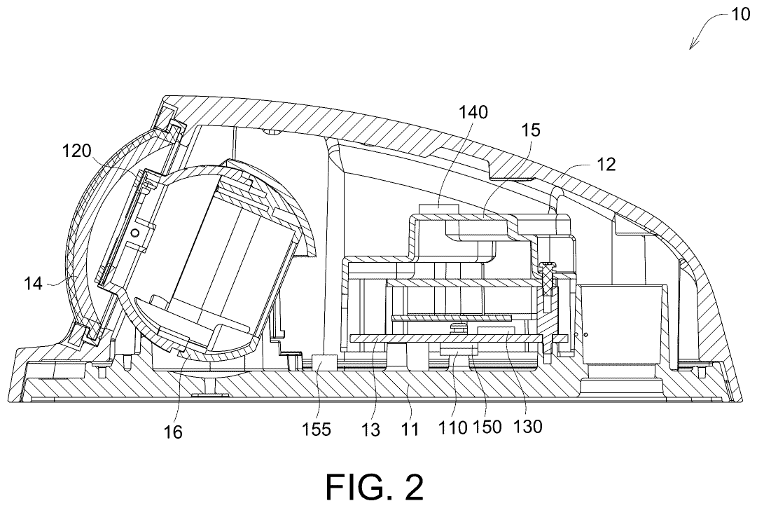

Referring to FIG. 2, FIG. 2 shows a schematic diagram of a temperature control system 100 disposed on a camera device 10 according to another embodiment of the present invention.

As shown in FIG. 2, the camera device 10 includes a temperature control system 100, a bottom shell 11, an upper shell 12, a circuit board 13, a window 14, a support frame 15 and a lens module 16. The sensing circuit 155 of the temperature control system 100 can be disposed on the bottom shell 11. In an specific embodiment, the sensing circuit 155 can contact the bottom shell 11 and can detect the temperature closest to the external environment (ambient temperature); the support frame 15 and the lens module 16 can be respectively disposed on the bottom shell 11; the circuit board 13 can be disposed inside the support frame 15; the window 14 can be disposed between the upper shell 12 and the bottom shell 11; the lens module 16 can capture an external image through the window 14; the processing module 150 can be disposed on the circuit board 13, and the first heater 110 can directly or indirectly connects to the processing module 150, wherein the first heater 110 can be disposed on the processing module 150, or the first heater 110 and the processing module 150 can be connected by an adhesive layer or colloid; the window 14 connects to the second heater 120, and includes but not limited to the second heater 120 being disposed on the window 14, or the second heater 120 being directly or indirectly connected to the window 14 for reducing the thermal resistance between the second heater 120 and the window 14; the first temperature control module 130 can be disposed on the circuit board 13. In a specific embodiment, the first temperature control module 130 and the processing module 150 may be respectively disposed on opposite two sides of the circuit board 13; the second temperature control module 140 may be disposed on the support frame 15.

Referring to FIGS. 1 and 2, the first predetermined temperature value Tem1 may be the temperature at which the window 14 of the camera device 10 freezes, the second predetermined temperature value Tem2 may be the temperature at which the window of the camera device fogs up, and the third predetermined temperature value Tem3 may be the temperature at which the window of the camera device does not fog up or is not easily fogged up. For example, the first predetermined temperature value Tem1 may be any temperature ranging between −25° C. and −15° C., the second predetermined temperature value Tem2 may be any temperature ranging between 5° C. and 15° C., and the third predetermined temperature value Tem3 may be any temperature ranging between 35° C. and 45° C., but this is not intended to limit the present invention.

In an embodiment, when a first power consumption of the first heater 110 is x watts, a second power consumption of the second heater 120 is y watts, a third power consumption of the processing module 150 is z watts, and the maximum allowable power consumption of the power supply (not shown) is K watts. The aforementioned x, y and K are, for example, real numbers greater than zero. In any mode of this invention, the first heater 110, the second heater 120 and the processing module 150 are not activated simultaneously, and thus the total power consumption of the first heater 110, the second heater 120, and the processing module 150 may not exceed the maximum allowable power consumption, that is, x+y<K in mode 1, y+z<K in mode 2, y+z<K or z<K in Mode 3, and z<K in Mode 4. Specifically, the first power consumption may be approximately 2.5 watts, the second power consumption may be approximately 2 watts, the third power consumption may be approximately 5.5 watts, and the aforementioned maximum allowable power consumption may be 8 watts, but this is not intended to limit this invention.

In an embodiment, to enable the processing module 150 to reach its operating temperature more quickly, the first heater 110 can be used to heat the processing module 150, while a second heater 120 can heat the window of the lens module. The first heater 110 and the second heater 120 can be flexible printed circuits (PCBs), and the processing module 150 can be an application-specific integrated circuit (ASIC).

A first temperature control module 130 can detect a first sensed temperature, and a second temperature control module 140 can detect a second sensed temperature. After the temperature control system 100 is activated, when the first sensed temperature is lower than the first predetermined temperature value Tem1, Mode 1 is executed, and the first temperature control module 130 can activate the first heater 110 to heat the processing module 150. When the second sensed temperature is lower than the first predetermined temperature value Tem1, the second temperature control module 140 controls the second heater 120 to activate.

When the temperature of the processing module 150 is equal to or greater than the first predetermined temperature value Tem1, Mode 2 is executed. Thereafter, the processing module 150 begins operation, obtains signal from the sensing circuit 155 and accordingly obtains a third sensed temperature by calculating. In Mode 2 to Mode 4, the processing module 150 controls the first heater 110 and/or the second heater 120 based on the third sensed temperature. Since the processing module 150 has begun operation, the processing module 150 can turn off the first heater 110. In Mode 2, the second heater 120 continues to heat the window.

When the third sensed temperature substantially equals or reaches the second predetermined temperature value Tem2, Mode 3 is executed. Since the temperature has risen to a certain level at this time, the processing module 150 can cause the second heater 120 to intermittently heat the window.

In Mode 4, when the third sensed temperature is substantially equal to or higher than the third predetermined temperature value Tem3, Mode 4 is executed. Since there is no need for the heat the window, the processing module 150 can turn off the second heater 120.

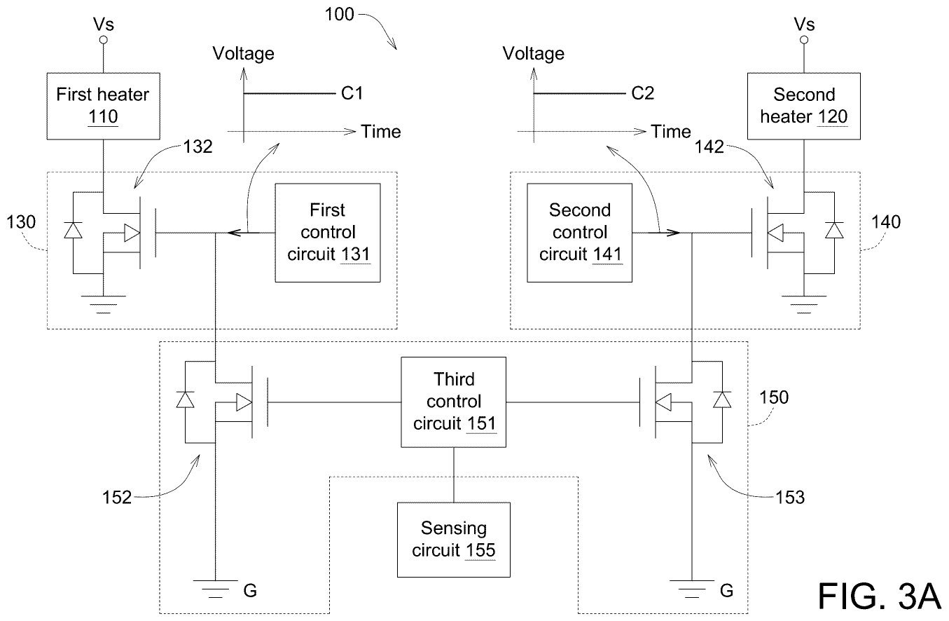

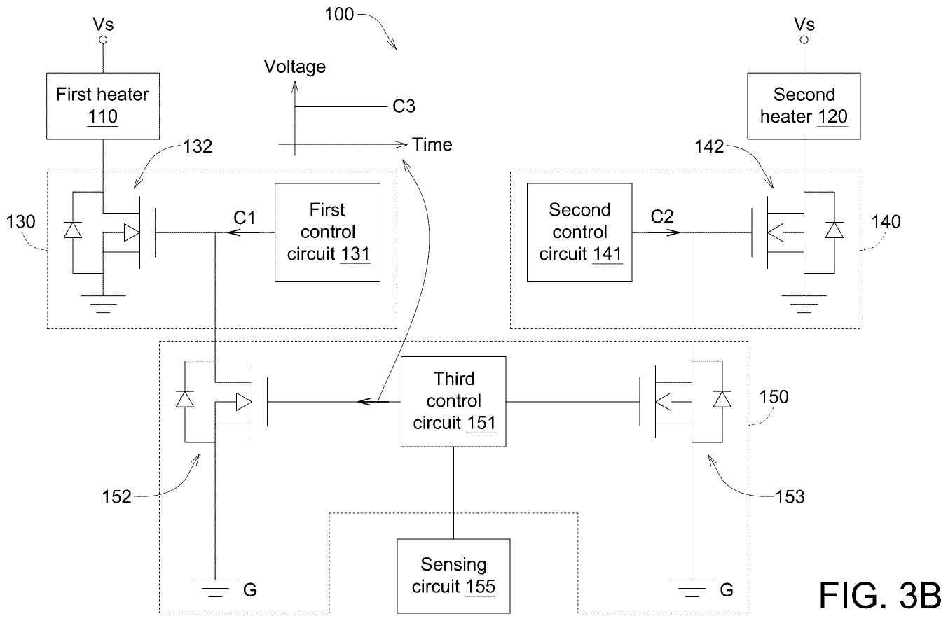

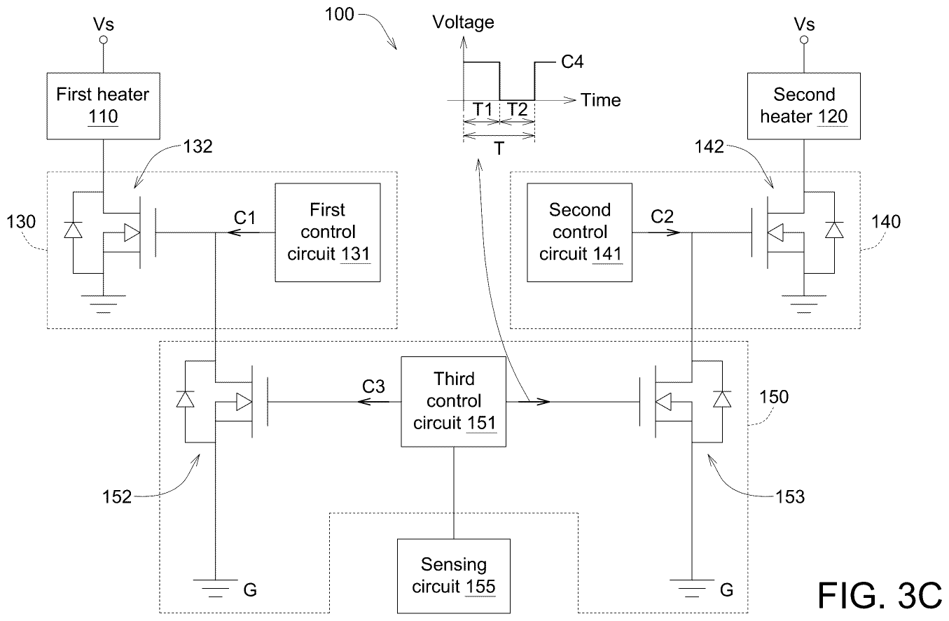

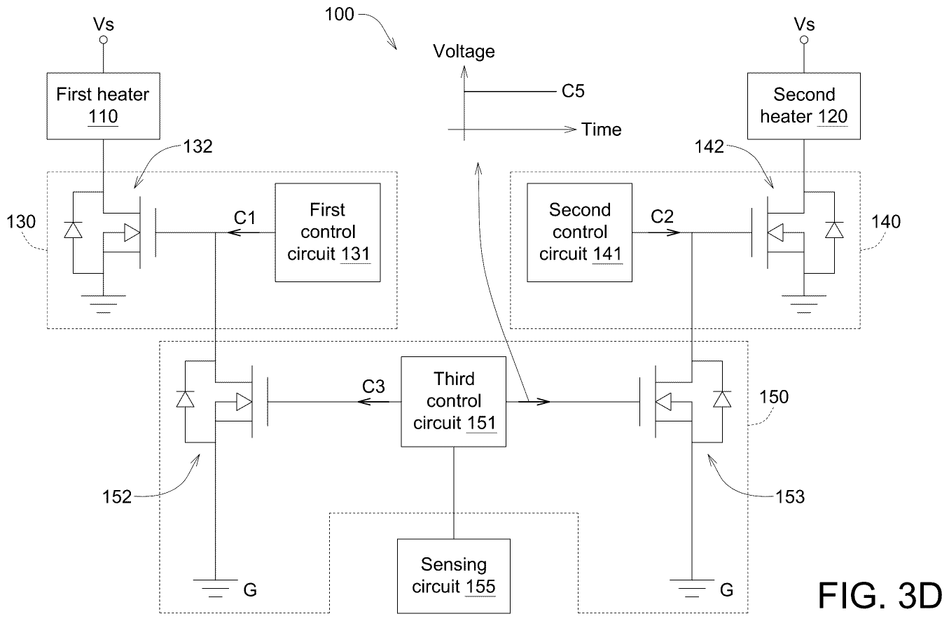

Referring to FIGS. 3A to 3D, FIG. 3A shows a schematic diagram of the camera device 10 in FIG. 1 in Mode 1, FIG. 3B shows a schematic diagram of the camera device 10 in FIG. 1 in Mode 2, FIG. 3C shows a schematic diagram of the camera device 10 in FIG. 1 in Mode 3, and FIG. 3D shows a schematic diagram of the camera device 10 in FIG. 1 in Mode 3.

As shown in FIG. 3A, the first temperature control module 130 includes a first control circuit (or temperature control circuit) 131 and a first switch 132, wherein the first switch 132 electrically connects to the first control circuit 131 and the first heater 110. The second temperature control module 140 includes a second control circuit 141 and a second switch 142, wherein the second switch 142 electrically connects to the second control circuit 141 and the second heater 120. The processing module 150 includes at least one third control circuit 151, a third switch 152 and a fourth switch 153, wherein the third switch 152 electrically connects to the first temperature control module 130 and the third control circuit 151. The fourth switch 153 electrically connects to the second temperature control module 140 and the third control circuit 151, wherein the sensing circuit 155 electrically connects to the third control circuit 151. In an embodiment, the sensing circuit 155 may include a thermistor, and the third control circuit 151 may detect a voltage value of the thermistor and obtain the third sensed temperature based on the voltage value.

In an embodiment, at least two of the first switch 132, the second switch 142, the third switch 152 and the fourth switch 153 may use the same electronic circuit, module or electronic component. In the present embodiment, at least one of the first switch 132, the second switch 142, the third switch 152, and the fourth switch 153 is an N-type metal-oxide-semiconductor field-effect transistor. In a specific embodiment, all of the first switch 132, the second switch 142, the third switch 152 and the fourth switch 153 are N-type metal-oxide-semiconductor field-effect transistors. In addition, the first control circuit 131 and the second control circuit 141 may each include a temperature regulating integrated circuit (for example, thermostat IC), but this invention is not limited thereto.

As shown in FIG. 3A, in Mode 1, the first control circuit 131 can output a first control signal C1 to a gate of the first switch 132. The first control signal C1 can drive the first switch 132 to be activated, thereby turning on the first heater 110. Specifically, the first control signal C1 can be a high-potential signal, and the first control signal C1 can be a constant voltage signal to keep the first heater 110 turning on; the second control circuit 141 can output a second control signal C2 to a gate of the second switch 142. The second control signal C2 can drive the second switch 142 to be activated, thereby turning on the second heater 120. Specifically, the second control signal C2 can be a high-potential signal, and the second control signal C2 can be a constant voltage signal to keep the second heater 120 turning on. In Mode 1, the third control circuit 151 is deactivated and has not yet started working, and accordingly the first control circuit 131 and the second control circuit 141 drive the first heater 110 and the second heater 120 respectively.

As shown in FIG. 3B, in Mode 2, the third control circuit 151 is activated and begins to work. The third control circuit 151 can output a third control signal C3, and the third control signal C3 drives the third switch 152 to be activated and electrically connect to a ground potential G. The ground potential G can cause the first switch 132 to be deactivated, thereby turning off the first heater 110 to stop heating. The third control signal C3 can be a high-potential signal. In Mode 2, the third control circuit 151 does not output a signal to the fourth switch 153, and thus the second control circuit 141 continues to control the second heater 120 to remain on.

As shown in FIG. 3C, in Mode 3, the third control circuit 151 can output a fourth control signal C4 to the fourth switch 153. The fourth control signal C4 can drive the second heater 120 to be activated intermittently, meaning that the fourth control signal C4 can drive the second heater 120 to repeatedly activate and deactivate at a fixed frequency. For example, the fourth control signal C4 is a pulse-width modulation (PWM) signal, and the third control circuit 151 may include a PWM circuit. Specifically, the fourth control signal C4 may include a plurality of cycles T, each cycle T includes a high-potential interval T1 and a low-potential interval T2. The high-potential interval T1 can drive the fourth switch 153 to be activated, thereby deactivating the second switch 142 for deactivating the second heater 120. The low-potential interval T2 can deactivate the fourth switch 153, thereby driving the second switch 142 to activate for activating the second heater 120. During the high-potential interval T1 of the cycle T, the second heater 120 is deactivated and pauses power consumption for saving energy.

In Mode 3, the duration (timing length) of the high-potential interval T1 and the duration of the low-potential interval T2 of the cycle T of the fourth control signal C4 can vary depending on the different third sensing temperatures. The following explains three temperature levels in duration of the second predetermined temperature value Tem2 to the third predetermined temperature value Tem3 in Mode 3. Furthermore, the duration between the second predetermined temperature value Tem2 and the third predetermined temperature value Tem3 can also include a fourth predetermined temperature value Tem4 and a fifth predetermined temperature value Tem5. The third control circuit 151 issues a corresponding fourth control signal C4 based on the level of the third sensed temperature, wherein the fourth predetermined temperature value Tem4 is less than the fifth predetermined temperature value Tem5 (Tem4<Tem5).

When the third sensed temperature ranges between the second predetermined temperature value Tem2 (e.g., including the endpoint value) and the fourth predetermined temperature value Tem4 (e.g., not including the endpoint value), the duration of the high-potential interval T1 can be shorter than the duration of the low-potential interval T2. For example, the second predetermined temperature value Tem2 is 10° C., the fourth predetermined temperature value Tem4 is 20° C., the duration of the high-potential interval T1 can be set to 2 seconds, and the duration of the low-potential interval T2 can be set to 5 seconds.

When the third sensing temperature ranges between the fourth predetermined temperature value Tem4 (e.g., including the endpoint value) and the fifth predetermined temperature value Tem5 (e.g., not including the endpoint value), the duration of the high potential interval T1 can be substantially equal to the duration of the low potential interval T2. For example, the fourth predetermined temperature value Tem4 is 20° C., the fifth predetermined temperature value Tem5 is 30° C., the duration of the high-potential interval T1 can be set to 5 seconds, and the duration of the low-potential interval T2 can be set to 5 seconds.

When the third sensed temperature ranges between the fifth preset temperature Tem5 (e.g., including the endpoint value) and the third predetermined temperature value Tem3 (e.g., not including the endpoint value), the duration of the high-potential interval T1 can be greater than the duration of the low-potential interval T2. For example, the fifth predetermined temperature value Tem5 is 30° C., the third predetermined temperature value Tem3 is 40° C., the duration of the high-potential interval T1 can be set to 8 seconds, and the duration of the low-potential interval T2 can be set to 2 seconds, but this invention is not limited thereto.

As shown in FIG. 3D, in Mode 4, the third control circuit 151 can issue a fifth control signal C5. The fifth control signal C5 can drive the fourth switch 153 to activate to electrically connect to the ground potential G. The ground potential G can cause the second switch 142 to deactivate, thereby deactivating the second heater 120 for saving energy. The fifth control signal C5 can be a high-potential signal.

In summary, the temperature control system 100 includes a plurality of heaters, a plurality of temperature control modules and a processing module. These heaters can be controlled separately by these temperature control modules. In an embodiment, the heater can be controlled by either the temperature control module or the processing module based on different sensed temperatures. In another embodiment, the processing module can control the heater to activate intermittently based on the sensed temperature for achieving energy-saving effects. In other embodiments, these heaters and the processing module are not activated simultaneously for achieving energy-saving effects.

While the invention has been described by way of example and in terms of the preferred embodiment(s), it is to be understood that the invention is not limited thereto. Based on the technical features embodiments of the present invention, a person ordinarily skilled in the art will be able to make various modifications and similar arrangements and procedures without breaching the spirit and scope of protection of the invention. Therefore, the scope of protection of the present invention should be accorded with what is defined in the appended claims.

What is claimed is:

1. A temperature control system, comprising:
a first heater;
a second heater;
a first temperature control module electrically connecting to the first heater;
a second temperature control module electrically connecting to the second heater; and
a processing module electrically connecting to the first temperature control module and the second temperature control module.

2. The temperature control system according to claim 1, wherein the first heater activates when a first sensed temperature detected by the first temperature control module is lower than a first predetermined temperature value, and/or the second heater activates when a second sensed temperature detected by the second temperature control module is lower than the first predetermined temperature value.

3. The temperature control system according to claim 1, the processing module performs at least one of following operations:
deactivating the first heater based on a third sensed temperature and the first predetermined temperature value;
intermittently activating and deactivating the second heater based on the third sensed temperature and a second predetermined temperature value; and
deactivating the second heater based on the third sensed temperature and a third predetermined temperature value.

4. The temperature control system according to claim 3, further comprising a sensing circuit, and the processing module obtains the third sensed temperature based on a signal from the sensing circuit.

5. The temperature control system according to claim 4, wherein a third control circuit outputs a pulse-width modulation (PWM) signal based on the third sensed temperature to drive the second heater to intermittently activate and deactivate.

6. The temperature control system according to claim 4, wherein the sensing circuit comprises a thermistor.

7. The temperature control system according to claim 1, wherein the first temperature control module comprises a first control circuit and a first switch, and/or the second temperature control module comprises a second control circuit and a second switch.

8. The temperature control system according to claim 7, wherein the first switch electrically connects the first control circuit and the first heater, and the second switch electrically connects the second control circuit and the second heater.

9. The temperature control system according to claim 1, wherein the processing module comprises a third control circuit, a third switch and a fourth switch.

10. The temperature control system according to claim 1, wherein the temperature control system satisfies at least one of following conditions:
the first temperature control module comprising a first control circuit and a first switch, and the first switch electrically connecting the first control circuit and the first heater;
the second temperature control module comprising a second control circuit and a second switch, and the second switch electrically connecting the second control circuit and the second heater; and
the processing module comprising a third control circuit, a third switch and a fourth switch, and the third switch electrically connecting the first temperature control module and the third control circuit, and the fourth switch electrically connecting the second temperature control module and the third control circuit.

11. The temperature control system according to claim 10, wherein the third control circuit comprises a pulse width modulation circuit, and/or at least one of the first switch, the second switch, the third switch and the fourth switch is an N-type metal-oxide-semiconductor field-effect transistor.

12. The temperature control system according to claim 1, wherein the first heater directly or indirectly heats the processing module.

13. A camera device, comprising:
a temperature control system as claimed in claim 1; and
a window connecting to the second heater.

14. The camera device according to claim 13, further comprising a sensing circuit, and the sensing circuit for detecting an ambient temperature.

15. A temperature control system, comprising:
a first temperature control module, detecting a first sensed temperature;
a first heater, activating based on the first sensed temperature and a first predetermined temperature value;
a second temperature control module, detecting a second sensed temperature;
a second heater, activating based on the second sensed temperature and the first predetermined temperature value; and
a processing module, deactivating the first heater based on a third sensed temperature and the first predetermined temperature value, intermittently activating and deactivating the second heater based on the third sensed temperature and a second predetermined temperature value, and/or deactivating the second heater based on the third sensed temperature and a third predetermined temperature value.

16. The temperature control system according to claim 15, further comprising a sensing circuit, and the processing module obtains the third sensed temperature based on a signal from the sensing circuit.

17. The temperature control system according to claim 16, wherein a third control circuit outputs a PWM signal based on the third sensed temperature to drive the second heater to intermittently activate and deactivate.

18. The temperature control system according to claim 16, wherein the sensing circuit comprises a thermistor, and/or the first heater heats the processing module.

19. The temperature control system according to claim 15, wherein the temperature control system satisfies at least one of following conditions:
the first temperature control module comprising a first control circuit and a first switch, and the first switch electrically connecting the first control circuit and the first heater;
the second temperature control module comprising a second control circuit and a second switch, and the second switch electrically connecting the second control circuit and the second heater; and
the processing module comprising a third control circuit, a third switch and a fourth switch, and the third switch electrically connecting the first temperature control module and the third control circuit, and the fourth switch electrically connecting the second temperature control module and the third control circuit.

20. The temperature control system according to claim 19, wherein the third control circuit comprises a pulse width modulation circuit, and/or at least one of the first switch, the second switch, the third switch and the fourth switch is an N-type metal-oxide-semiconductor field-effect transistor.
